(19) United States
(12) Patent Application Publication
(10) Pub. No.: US 2006/0154728 A1
(43) Pub. Date: Jul. 13, 2006

(54) Game apparatus and method

(76) Inventor: Doreen Plummer, Freeport (BS)

Correspondence Address: MONIQUE A. MORNEAULT, ESQ.;WALLENSTEIN WAGNER & ROCKEY, LTD., 311 South Wacker Drive - 5300, Chicago, IL, 60606, US

(21) Appl. No.: 11/297,889

(22) Filed: Dec. 8, 2005

(30) Foreign Application Priority Data
Dec. 10, 2004 (GB) 0427161.5

(51) Int. Cl. A63F 13/00

(52) U.S. Cl. 463/42; 463/25; 463/21

(57) ABSTRACT

A method and device for playing a game is disclosed. The game includes the steps of providing prizes, providing play advancement means between a group of players playing the game, and sequentially transferring the play advancement means from one player to the next, subject to any random event indicator indicating otherwise and continuing to play the game until a time limit is reached.

### REFERENCE TO RELATED APPLICATION

The present application claims priority to and the benefit of British Appln. No. 0427161.5, filed on Dec. 10, 2004, which application is incorporated by reference and made a part hereof.

### BACKGROUND OF THE INVENTION

This invention relates to games and methods of playing games which are particularly suited to social occasions such as parties, celebrations or informal functions where enjoyment and excitement may be enhanced by winning prizes, which may be confiscated or transferred from one player to another as the game progresses.

### SUMMARY OF THE INVENTION

According to the invention in a first aspect there is provided a method of playing a game comprising the steps of providing a store of concealed prizes for viewing at a selection point, providing play advancement means whereby an initial “win” condition may be indicated, between a group of players playing the game, sequentially transferring the play advancement means from one player to the next, subject to any random event indicator indicating otherwise, following initial winning of all of the prizes or completion of a time limit, revealing the initially won prizes from the selection points and thereafter setting a time limit to continue playing the game by means of the play advancement means to thereafter choose a revealed prize initially won by any of the other players within the group or which had initially been won but returned to the selection point on the happening of a random event requiring such, continuing the game until the time limit is reached, whereafter players with prizes may thereafter keep them, or trade them for other prizes owned by other players in the group.

Although the play advancement means may include random event indicators such as playing cards, dice etc, preferably it comprises a battery operated electronic random event indicator which includes a start function sequentially operable by each player which thereafter indicates a random event condition visually and/or aurally, such as to take a prize from the selection point, which may initially be in the form of a wrapped gift, to take no such prize, to lose a turn, to take two prizes, and to return a prize to the selection point.

The invention in a second aspect also extends to the concept of a packaged set of a play advancement device and assorted initially concealed prizes, the prizes being selected according to the requirements of the player group. For example, where the player group consists of or includes children the prizes may be in the form of concealed toys or sweets and the like. Where the player group consists of adults the concealed prizes may be adult toys, thereby providing enhanced excitement and anticipation for the player group during and after playing of a game.

The invention in a third aspect also extends to an electrically operable play advancement device adapted for use in playing a game in accordance with the method of the invention, the device including means for generating or indicating an initial “win” condition, means for indicating a random event indicating otherwise, and a timer to indicate when a given, or selected or random time limit has been reached, thereby indicating the end of the game.

### BRIEF DESCRIPTION OF THE DRAWINGS

The invention will now be described, by way of example only, with reference to the accompanying drawings in which:

FIG. 1 is a simplistic plan view of game play advancement means for use in playing a game in accordance with the method of the invention, and

FIG. 2 is a preferred embodiment of game play advancement means to that shown in FIG. 1.

### DETAILED DESCRIPTION OF THE INVENTION

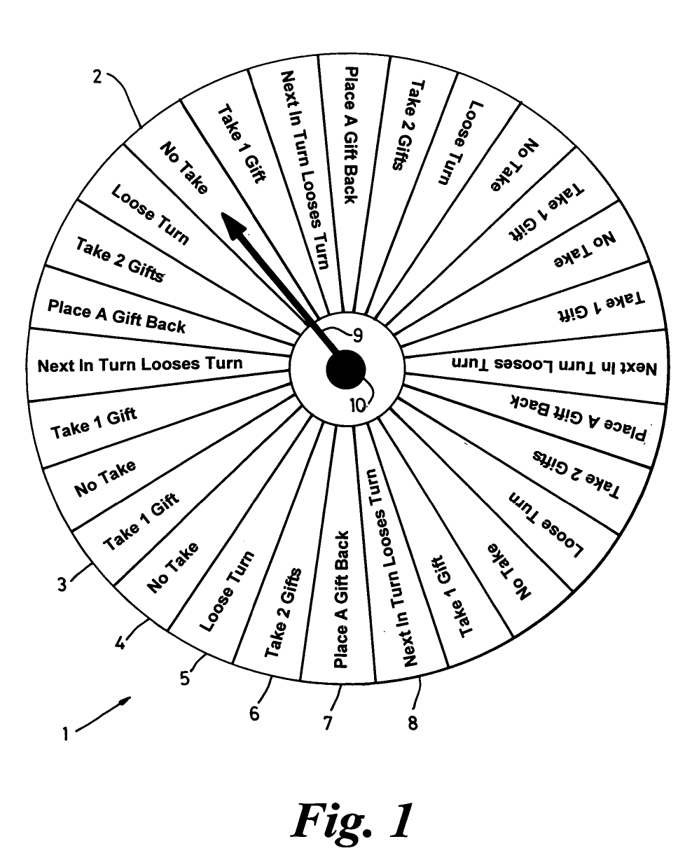

Turning firstly to FIG. 1 there is shown a game play advancement means 1 comprised of a segmented disc 2 on which are randomly displayed segments showing any one of multiple random event indications 3, 4, 5, 6, 7 and 8 disposed sequentially around the disc 2. Disposed radially on the disc 2 is a rotatable pointer 9 and associated actuating knob 10 by which it may be spun and thereafter allowed to come to rest to randomly indicate one of the segments 3, 4, 5, 6, 7 or 8.

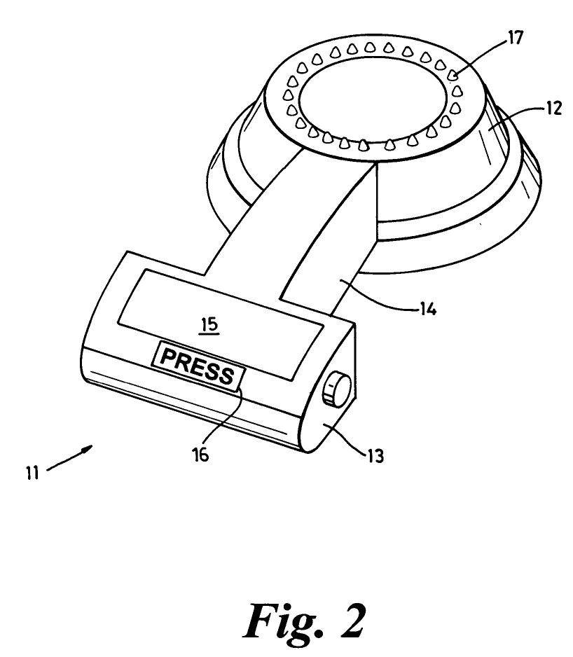

In FIG. 2 there is shown a preferred embodiment of play advancement device 11 which includes a casino roulette style circular head portion 12 for indicating an initial “win” condition and randomly generated event indications corresponding to the indications appearing on the segments 3, 4, 5, 6, 7 and 8 of FIG. 1. The circular head portion is physically and electrically connected to a play initiator portion 13 by means of an arm 14 and includes a visual display panel 15 which may contain options such as “play” or “advance play” or “exit” or “end game” or “set timer” and a start button 16 for commencing operation of the play advancement device 11. The play advancement device also includes in the head portion 12 a circular set of lights 17 which may. sequentially light up to mimic the appearance of a roulette wheel as it spins, the lights continuing to flash in sequence until a random signal is generated to end play, thereafter indicating a condition, such as a “win” condition, achieved by the player concerned. Thereafter, the play initiator portion 13 can then be swivelled left or right in the directions arrowed, as the case may be, to the next player whose turn it is to play, the circular head portion 12 remaining in position in e.g. the middle of the table so as to be always visible to players.

Optionally, the play advancement device 11 in accordance with the preferred embodiment may also include audio or other visual features in order to enhance excitement during play.

The method of playing the game accorded to the invention will now be described with reference to the play advancement device 11 shown in FIG. 2, utilising the random events indicated in the segments 3, 4, 5, 6, 7 and 8 of FIG. 1.

To play a game in accordance with the method of the invention a store of concealed prizes (not shown), such as a number of wrapped gifts, are placed at a convenient selection point, such as at the centre of a table in full view of everyone and without any indication as to what each prize is. If the players of the game are children then a range of different toys may be provided. On the other hand, if the players are adults, adult toys or other prizes may be chosen depending upon their suitability for the players concerned.

The game begins by each player in turn operating the play advancement means 1 or 11, although it will be understood that other type of play advancement means could be used, such as specially marked cards or even dice where numbers thrown can be checked against a look-up table to determine what random event has been indicated.

Referring to the play advancement means 1 in the form of a disc 2 and rotatable pointer 9, following the latter being spun by the actuating knob 10 it may land on any one of the five random event indicators, 3 requiring the player to take one prize from the selection point, 4 denying the player anything, 5 indicating that the player loses a turn, perhaps even the next, 6 meaning that the player can take two prizes from the selection point, 7 requiring the player to return a prize to the selection point and 8 requiring the player to take one prize but the next person who would ordinarily play to miss a turn.

In a variation to the method of playing the game, only a selected few of the prizes in the prize store are selected and placed e.g. in the centre of a table around which players are sat. When all of the prizes have been won that may signal the end of a first round, whereafter several more prizes may be taken from the prize store and placed at the selection point for the next round to continue, or each round may finish with players keeping those prizes in their possession at the end of each round. The game may, therefore, optionally be played sequentially or cumulatively depending upon the number of prizes available in the prize store and the availability and interest of players.

1. A method of playing a game comprising the steps of:
providing prizes;
providing a group of players;
providing play advancement means having a plurality of random event indicators between the group of players;
sequentially transferring the play advancement means from one player to the next;
selecting prizes;
setting a time limit to continue playing the game;
continuing play until the time limit is reached, wherein players with prizes may keep the prizes, or trade the prizes for other prizes owned by other players in the group.

2. The method of playing the game of claim 1, wherein the play advancement means is a disc and rotatable pointer.

3. The method of playing the game of claim 1, wherein the play advancement means is a battery operated electronic random event indicator.

4. The method of playing the game of claim 3, wherein the play advancement means includes a start function sequentially operable by each player which indicates a random event condition visually and/or aurally.

5. The method of playing the game of claim 4, wherein the random event condition includes selection of a prize, no selection of the prize, lose a turn, take two prizes, or return the prize to a selection point.

6. An electrically operable play advancement device adapted for use in playing a game in accordance with the method of the invention as claimed in claim 1, the device comprising means for indicating a random event and a timer to indicate when a time limit has been reached indicating the end of the game.

7. The device of claim 6, wherein the device includes a roulette style circular head portion containing a plurality of segments showing multiple random event indicators.

8. The device of claim 6, wherein the device includes audio or visual features.

9. The device of claims 6, wherein the timer indicates an end of a period in the game.

10. A method of playing a game comprising the steps of providing concealed prizes for viewing at a selection point, providing play advancement means whereby an initial “win” condition may be indicated, between a group of players playing the game, sequentially transferring the play advancement means from one player to the next, subject to any random event indicator indicating otherwise, following initial winning of all of the prizes or completion of a time limit, revealing the initially won prizes from the selection points and thereafter setting a time limit to continue playing the game by means of the play advancement means to thereafter choose a revealed prize initially won by any of the other players within the group or which had initially been won but returned to the selection point on the happening of a random event requiring such, continuing the game until the time limit is reached, wherein players with prizes may keep them, or trade them for other prizes owned by other players in the group.
